(19) United States
(12) Patent Application Publication
(10) Pub. No.: US 2016/0137521 A1
(43) Pub. Date: May 19, 2016

(54) METHOD AND SYSTEM FOR EXTRACTING RED-MUD LUMPS FROM SLURRY

(71) Applicant: Sesa Sterlite Limited, Odisha (IN)

(72) Inventors: Mukesh KUMAR, New Delhi (IN); Bimalananda SENAPATI, Kolkata (IN); Chikkala Sateesh KUMAR, Andhra Pradesh (IN)

(21) Appl. No.: 14/659,217

(22) Filed: Mar. 16, 2015

(30) Foreign Application Priority Data
Nov. 15, 2014 (IN) 1182/KOL/2014

(51) Int. Cl. C01F 7/06; B01D 25/28; B01D 25/12

(52) U.S. Cl. CPC C01F 7/0646; B01D 25/12; B01D 25/281; B01D 25/282

(57) ABSTRACT

The present invention provides a method and system for extracting a plurality of red mud lumps from a slurry. The method and system includes separating an aqueous content from the slurry by simultaneous action of one or more de-watering agents and a physical force, and extracting the plurality of red-mud lumps having a moisture content of less than 18 percent from a slurry mixture. The separating of the aqueous content from the slurry includes feeding the slurry mixture to a filtering arrangement, exerting a first physical force to the slurry mixture in the filtering arrangement; and exerting a second physical force to the slurry mixture in the filtering arrangement. The slurry mixture includes the slurry and the one or more de-watering agents in a pre-determined quantity. The filtering arrangement is utilized for the extracting of the plurality of red-mud lumps from the slurry.

### TECHNICAL FIELD

The present invention relates to the field of treatment of slurry, and in particular, relates to extraction of red-mud lumps from treatment of slurry.

### BACKGROUND

With the advent of highly sophisticated technological machines and assemblies, most of the industries are striving hard to chalk out innovative processes which effectively utilize natural resources and reduce their wastage. In the existing industrial methods, some of the precious metals present in the natural resources are not extracted properly and are counted as industrial waste. For example, in in alumina industry, one of the widely known industrial waste resources used is slurry which is left out after separating alumina laden liquor from bauxite. The slurry has red-mud which is an insoluble residue of bauxite alkali leaching process of alumina production. However, this red-mud is rich in iron, titanium dioxide, silica, alumina and some other useful minerals of high commercial importance.

In addition, due to huge land requirement and environmental hazard involved due to alkaline nature of the red-mud, disposal and utilization of the red-mud has always been a matter of concern for environmentalists as well as the alumina industries. Even after years of storage, the disposed off red-mud remains in semi-fluid form and pose serious threats during earth movement or leakage from earthen dyke walls into surroundings and ecological environment including soil, water and ground-water. This results in many direct and indirect effects on ecosystem. Moreover, the re-use of the industrial waste resources like the red-mud may help in eliminating the environmental and the disposal problems to an extent.

Currently, the red-mud is disposed-off into red-mud ponds where the red-mud remains for years without being used. During the construction of the red-mud ponds, alumina refineries need to ensure application of impervious layer like high density poly ethylene layer to prevent alkaline liquor contamination to the ground-water so that it may not lead to the alkaline liquor infiltration into the ground and cause the ground-water contamination. Further, the dumping of the red-mud into water bodies leads to water pollution and cause threat to the environment.

In light of the above stated discussion, there is a need for a method and system that overcomes above stated disadvantages. Further, the method and system should provide re-utilization of the red-mud stored in the red-mud ponds.

### SUMMARY

In an aspect of the present invention, a filtering arrangement for extracting a plurality of red mud lumps from a slurry is provided. The filtering arrangement includes one or more slurry storage chamber arrangements to receive a slurry mixture, one or more filter chamber arrangements to filter the aqueous content from the slurry mixture, and one or more water squeezing chamber arrangements to apply a second physical force at a second pre-defined pressure to the slurry mixture. The slurry mixture includes the slurry and one or more de-watering agents in a pre-determined quantity. The slurry results from alkaline digestion of bauxite and has a plurality of red-mud particles dispersed in an aqueous content. The slurry mixture is received from the one or more slurry storage chamber arrangements by a first physical force at a first pre-defined pressure to extract the plurality of red-mud lumps the slurry mixture. The plurality of red-mud lumps has a moisture content of less than 18 percent from. The one or more water squeezing chamber arrangements exerts the second physical force by directing a stream of water on the slurry mixture in the filtering arrangement. A difference between the second pre-defined pressure and the first pre-defined pressure is in a range of 3-6 bars.

In an embodiment of the present invention, the filtering arrangement includes one or more filtrate collecting arrangements to collect a filtrate generated from the extraction of the plurality of red-mud lumps from the slurry mixture.

In another embodiment of the present invention, the filtering arrangement includes a cloth washing arrangement to wash a filter cloth of each of the one or more filter chamber arrangements of the filtering arrangement by advancing a stream of water to the filter cloth for a pre-defined time interval.

In yet another embodiment of the present invention, each of the one or more filter chamber arrangements is high pressure plate and frame cum membrane filters.

In yet another embodiment of the present invention, each of the extracted plurality of red-mud lumps includes at least one of sodium as sodium hydroxide and sodium carbonate, iron as ferrous oxide, titanium as titanium dioxide, silicon as silica and aluminium as alumina.

In yet another embodiment of the present invention, the filtering arrangement includes an air compression arrangement to pass compressed air in each of the one or more filter chamber arrangements to push remnant slurry to the one or more slurry storage chamber arrangements.

In another aspect of the present invention, a method for extracting a plurality of red-mud lumps from a slurry is provided. The slurry results from alkaline digestion of bauxite and has a plurality of red-mud particles dispersed in an aqueous content. The method includes separating the aqueous content from the slurry by simultaneous action of one or more de-watering agents and a physical force and extracting the plurality of red-mud lumps having a moisture content of less than 18 percent from the slurry mixture. The one or more de-watering agents affect at least one of surface tension and drainage of the aqueous content of the slurry and water repellent property of the plurality of red-mud particles. The separating of the aqueous content from the slurry includes feeding the slurry mixture to a filtering arrangement, exerting a first physical force to the slurry mixture at a first pre-defined pressure in the filtering arrangement; and exerting a second physical force to the slurry mixture at a second pre-defined pressure. The slurry mixture includes the slurry and the one or more de-watering agents in a pre-determined quantity. The filtering arrangement is utilized for the extracting of the plurality of red-mud lumps from the slurry. A difference between the second pre-defined pressure and the first pre-defined pressure is in a range of 3-6 bars.

In an embodiment of the present invention, the slurry includes two or more of sodium hydroxide, sodium carbonate, ferrous oxide, titanium dioxide, silica and alumina and each of the plurality of red-mud lumps includes at least one of sodium as the sodium hydroxide and the sodium carbonate, iron as the -ferrous oxide, titanium as the titanium dioxide, silicon as the silica and aluminium as the alumina.

In another embodiment of the present invention, the pre-determined quantity of the one or more de-watering agents is based on a moisture content of the slurry and the surface tension of the aqueous content of the slurry.

In yet another embodiment of the present invention, 50-500 grams of the one or more de-watering agents is mixed with per ton of the plurality of red-mud particles.

In yet another embodiment of the present invention, the simultaneous action of the one or more de-watering agents and the physical force on the slurry mixture is performed by at least one of high pressure plate and frame cum membrane filters of the filtering arrangement.

In yet another embodiment of the present invention, the exerting of the second physical force to the slurry mixture includes directing a stream of a washing fluid to the slurry mixture in the filtering arrangement. The directing squeezes the slurry mixture to filter the aqueous content from the slurry mixture in the filtering arrangement.

In yet another embodiment of the present invention, the extracting of the plurality of red-mud lumps having the moisture content of less than 18 percent includes the separating of the slurry mixture to the filtering arrangement for 8 minutes, the exerting of the first physical force and the exerting of the second physical force for 3 minutes; and a compression of air for 1 minute, opening of the filtering arrangement for discharging of the plurality of red-mud lumps for 6 minutes and closing of a drip tray and readiness of the filtering arrangement for 2 minutes.

In yet another embodiment of the present invention, the method includes collecting a filtrate generated from the extraction of the plurality of red-mud lumps from the slurry mixture.

In yet another embodiment of the present invention, the method includes washing a filter cloth of each of the high pressure plate and frame cum membrane filters of the filtering arrangement by advancing a stream of water to the filter cloth for a pre-defined time interval.

In yet another aspect of the present invention, a method for extracting a plurality of red-mud lumps from a slurry is provided. The slurry results from alkaline digestion of bauxite and has a plurality of red-mud particles dispersed in an aqueous content. The method includes separating the aqueous content from the slurry, washing a filter cloth of each of one or more filter chamber arrangements of the filtering arrangement, and extracting the plurality of red-mud lumps having a moisture content of less than 18 percent from the slurry mixture. The separating is triggered by simultaneous action of one or more de-watering agents and a physical force. The one or more de-watering agents affect at least one of surface tension and drainage of the aqueous content of the slurry and water repellent property of the plurality of red-mud particles.

Further, the separating of the aqueous content from the slurry includes supplying a slurry mixture of the slurry and the one or more de-watering agents in a pre-determined quantity, applying a first physical force to the slurry mixture, and exerting a second physical force to the slurry mixture. The pre-determined quantity of the one or more de-watering agents is based on a moisture content of the slurry and the surface tension of the aqueous content of the slurry. The filtering arrangement is utilized for the extracting of the plurality of red-mud lumps from the slurry and the slurry is fed to the filtering arrangement. The first physical force is applied at a first pre-defined pressure in the filtering arrangement. The second physical force is exerted at a second pre-defined pressure. A difference between the second pre-defined pressure and the first pre-defined pressure is in a range of 3-6 bars.

In an embodiment of the present invention, the washing is performed by advancing a stream of water to the filter cloth for a pre-defined time interval.

In another embodiment of the present invention, the exerting of the second physical force to the slurry mixture includes directing a stream of a washing fluid to the slurry mixture in the filtering arrangement. The directing squeezes the slurry mixture to filter the aqueous content from the slurry mixture in the filtering arrangement.

In yet another embodiment of the present invention, the method includes collecting a filtrate generated from the extraction of the plurality of red-mud lumps from the slurry mixture.

In yet another embodiment of the present invention, the slurry includes two or more of sodium hydroxide, sodium carbonate, ferrous oxide, titanium dioxide, silica and alumina. Each of the plurality of red-mud lumps includes at least one of sodium as the sodium hydroxide and the sodium carbonate, iron as the ferrous oxide, titanium as the titanium dioxide, silicon as the silica and aluminium as the alumina.

### BRIEF DESCRIPTION OF THE FIGURES

Having thus described the invention in general terms, reference will now be made to the accompanying drawings, which are not necessarily drawn to scale, and wherein:

FIG. 1A illustrates a system for extracting a plurality of red-mud lumps from a slurry, in accordance with various embodiments of the present invention;

FIG. 1B illustrates the system for extracting the plurality of red-mud lumps from the slurry, in accordance with various other embodiments of the present invention;

FIG. 2A illustrates a system for providing a detailed functioning of a filtering arrangement for extracting the plurality of red-mud lumps from the slurry, in accordance with various embodiments of the present invention;

FIG. 2B illustrates the system for providing more detailed functioning of the filtering arrangement for extracting the plurality of red-mud lumps from the slurry, in accordance with various embodiments of the present invention;

FIG. 3 illustrates a system for providing a detailed functioning of a filter chamber arrangement of the one or more filter chamber arrangements of the filtering arrangement, in accordance with various embodiments of the present invention;

FIG. 4A illustrates a system for demonstrating a cloth washing process of a high pressure plate and frame cum membrane filter, in accordance with various embodiments of the present invention;

FIG. 4B illustrates the system for describing in detail the cloth washing process of the high pressure plate and frame cum membrane filter, in accordance with various embodiments of the present invention;

FIG. 5 illustrates a flowchart for extracting the plurality of red-mud lumps from the slurry, in accordance with various embodiments of the present invention;

FIG. 6 illustrates another flowchart for extracting the plurality of red-mud lumps from the slurry, in accordance with various embodiments of the present invention;

FIG. 7 illustrates yet another flowchart for extracting the plurality of red-mud lumps from the slurry, in accordance with various embodiments of the present invention;

FIG. 8 illustrates yet another flowchart for extracting the plurality of red-mud lumps from the slurry, in accordance with various embodiments of the present invention; and

FIG. 9 illustrates a flowchart for demonstrating the cloth washing process of the one or more filter chamber arrangements, in accordance with various embodiments of the present invention.

### DETAILED DESCRIPTION

It should be noted that the terms “first”, “second”, and the like, herein do not denote any order, quantity, or importance, but rather are used to distinguish one element from another. Further, the terms “a” and “an” herein do not denote a limitation of quantity, but rather denote the presence of at least one of the referenced item.

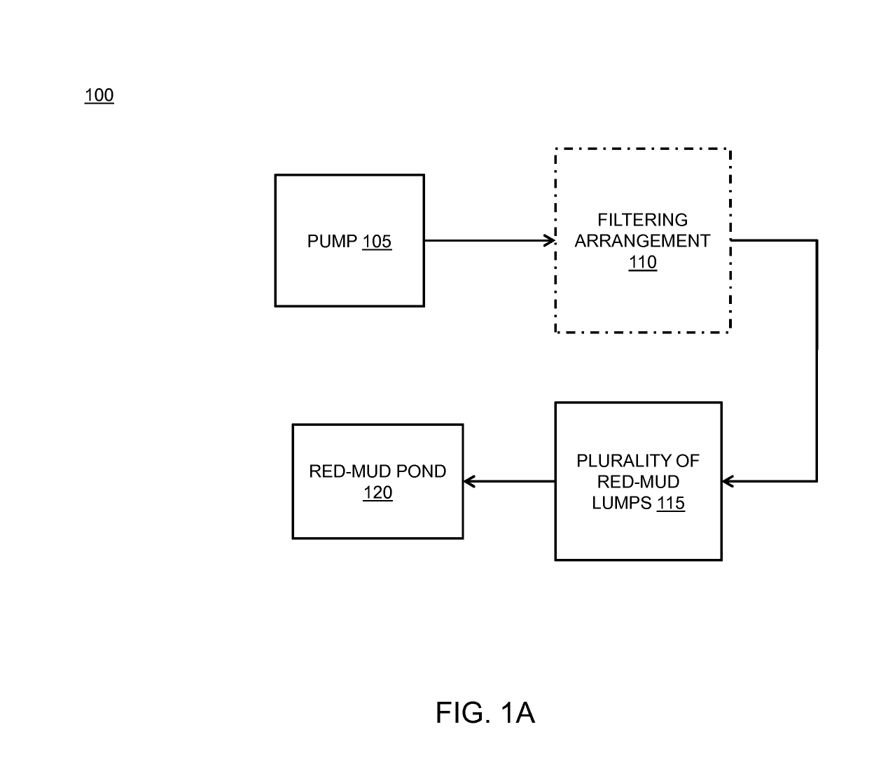

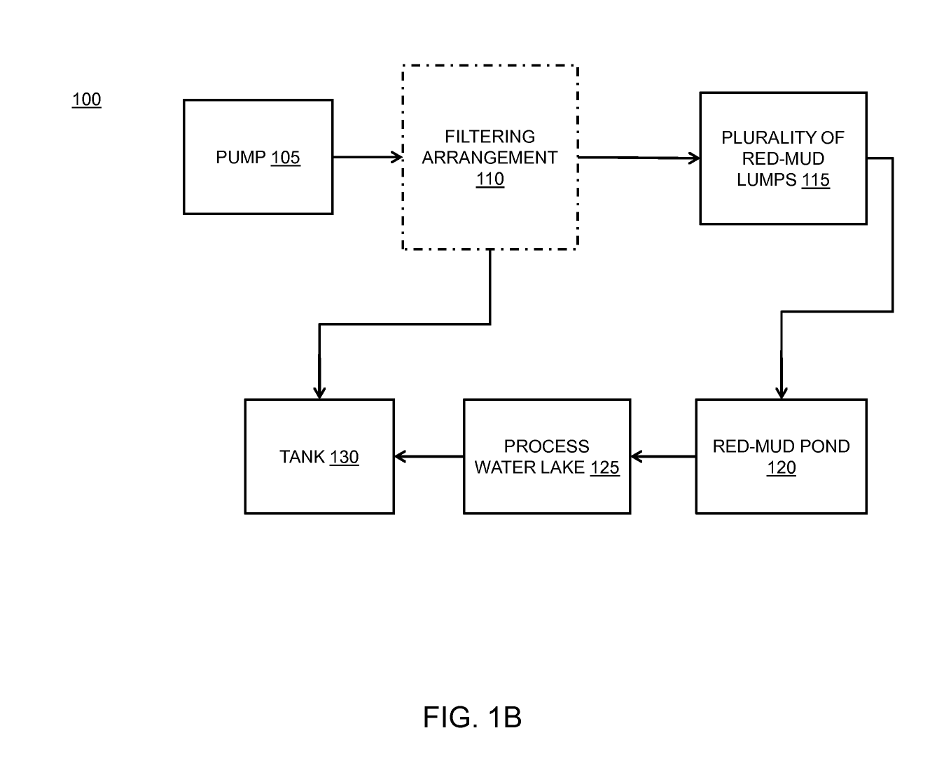

FIG. 1A illustrates a system 100 for extracting a plurality of red-mud lumps from a slurry, in accordance with various embodiments of the present invention. The plurality of red-mud lumps are tailings of alumina refinery. Further, the plurality of red-mud lumps can be solidified red-mud or partially solidified red-mud. The solidified red-mud or partially solidified red-mud can be used as raw material in different industrial processes. For example, the plurality of red-mud lumps can be used for production of low cost concrete in cement industry. The slurry results from alkaline digestion of bauxite. The alkaline digestion of bauxite includes grinding the bauxite with a sodium aluminate liquor to digest the bauxite. The bauxite is an aluminum ore used as a raw material for production of alumina.

The slurry includes the plurality of red-mud particles dispersed in the aqueous content. The plurality of red-mud particles are an insoluble residue generated from refining the bauxite en route to the alumina. The plurality of red-mud particles are rust colored particles having a solid concentration in a range of 25 percent to 55 percent (high caustic with the aqueous content), pH in the range of 13 and high ionic strength. The aqueous content may include water or any other liquid.

The system 100 includes a pump 105, a filtering arrangement 110, a plurality of red-mud lumps 115 and a red-mud pond 120. Examples of the pump 105 may include but not be limited to GEHO pumps or any other pump presently known in the art which is capable of gushing/spurting out the slurry in a sudden and forceful stream to the filtering arrangement 110. In an embodiment of the present invention, the filtering arrangement 110 may include an arrangement of filters, tanks, pumps, valves and other industrial system elements presently known in the art for extracting the plurality of red-mud lumps 115 from the slurry.

The pump 105 spurts out a slurry mixture to the filtering arrangement 110. In an embodiment of the present invention, the slurry mixture includes the slurry and one or more de-watering agents in a pre-determined quantity. The one or more de-watering agents are aids for drying/soaking the aqueous content of the slurry mixture. Examples of the one or more de-watering agents include sodium dialkyl sulfosuccinates, polyalkoxylated amines, modified lipids or any other compound presently known in the art which may soak the aqueous content of the slurry mixture. Further, the one or more de-watering agents affect at least one of surface tension and drainage of the aqueous content of the slurry and water repellant property of the plurality of red-mud particles. The one or more de-watering agents make the plurality of red-mud particles hydro-phobic (water-repellant).

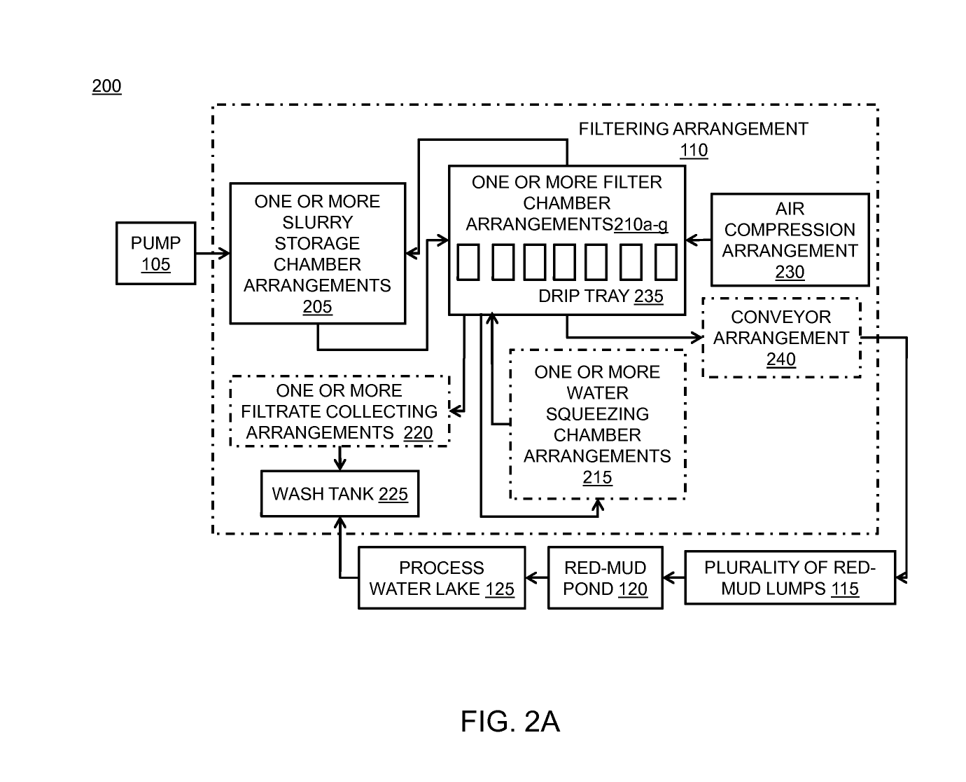

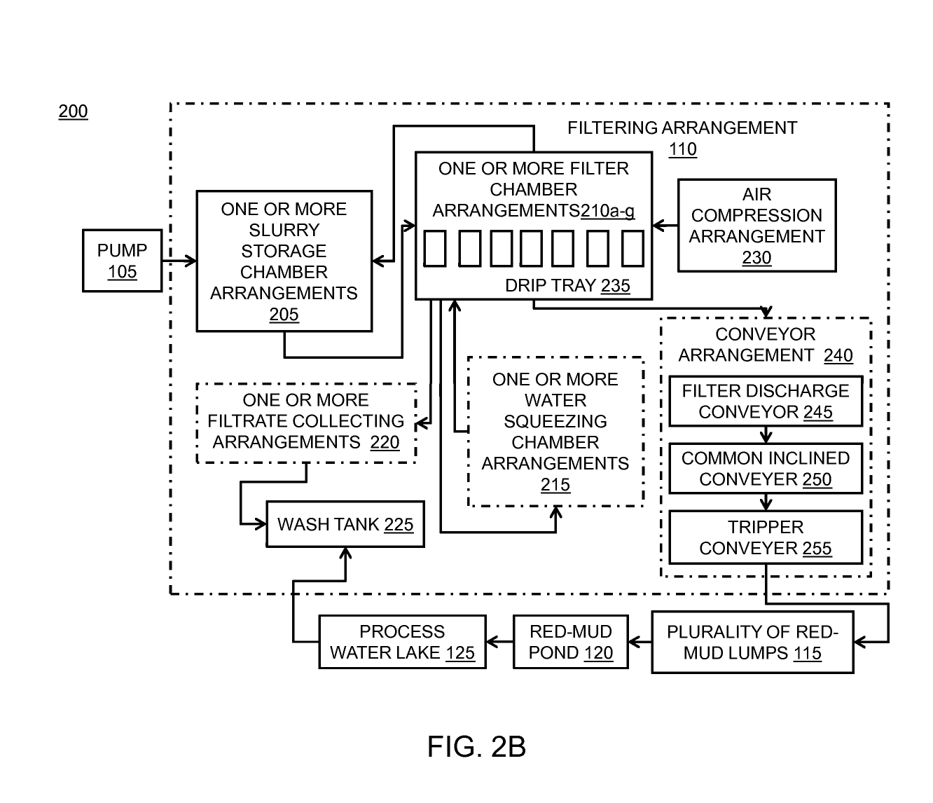

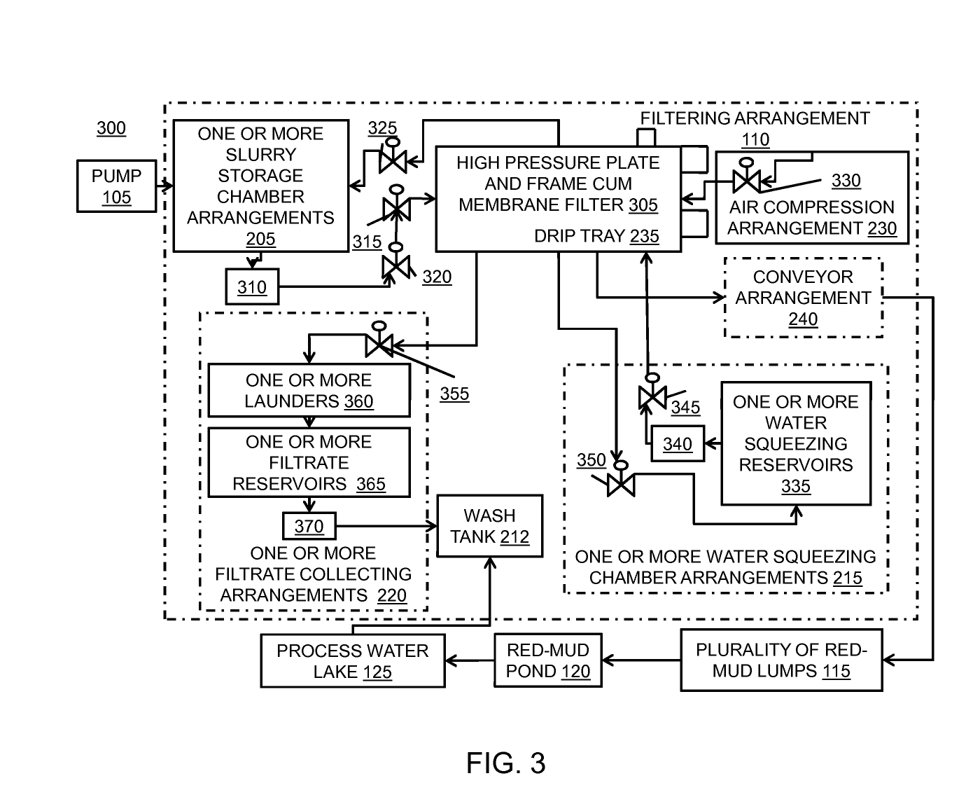

The filtering arrangement 110 extracts the plurality of red-mud lumps 115 from the slurry mixture. Further, the filtering arrangement 110 removes the aqueous content from the slurry mixture by simultaneous action of the one or more de-watering agents and a physical force. In an embodiment of the present invention, the physical force is a continuous pressure applied on the slurry mixture (as elaborated with the detailed description of FIG. 2A and FIG. 3). In an embodiment of the present invention, the plurality of red-mud lumps 115 includes 82 percent to 84 percent of the plurality of red-mud particles. In addition, the filtering arrangement 110 transfers the extracted plurality of red-mud lumps 115 to the red-mud pond 120. The red-mud pond 120 is an open structure for storing the plurality of red-mud particles or the extracted plurality of red-mud lumps 115.

It may be noted that in FIG. 1A, the pump 105 transfers the slurry mixture into the filtering arrangement 110; however those skilled in the art would appreciate that the system 100 may include one or more pumps to transfer the slurry mixture to the filtering arrangement 110.

FIG. 1B illustrates the system 100 for extracting the plurality of red-mud lumps 115 from the slurry, in accordance with various other embodiments of the present invention. It may be noted that to explain the FIG. 1B, references will be made to the system elements of FIG. 1A. The FIG. 1B includes the pump 105, the filtering arrangement 110, the plurality of red-mud lumps 115, the red-mud pond 120, a process water lake 125 and a tank 130. The pump 105 spurts the slurry mixture (the slurry extracted en route to the aluminium refining along with the one or more de-watering agents) into the filtering arrangement 110. The filtering arrangement 110 extracts the plurality of red-mud lumps 115 from the slurry mixture (as illustrated in the detailed description of FIG. 1A). Further, the filtering arrangement 110 transfers the extracted plurality of red-mud lumps 115 to the red-mud pond 120.

In addition, the filtering arrangement 110 discharges a filtrate. The tank 130 collects the discharged filtrate from the filtering arrangement 110. Furthermore, the aqueous content left in the plurality of red-mud lumps 115 flows out from the red-mud pond 120 to the process water lake 125. The process water lake 125 passes the aqueous content of the plurality of red-mud lumps 115 to the tank 130. Further, the tank 130 stores the aqueous content left in the plurality of red-mud lumps 115 and uses the aqueous content for washing application of the plurality of red-mud particles in a tail end thickener.

It may be noted that in FIG. 1B, the tank 130 collects the discharged filtrate from the filtering arrangement 110; however those skilled in the art would appreciate that the system 100 may include one or more tanks to collect the discharged filtrate from the filtering arrangement 110.

FIG. 2A illustrates a system 200 for providing a detailed functioning of the filtering arrangement 110 for extracting the plurality of red-mud lumps 115 from the slurry, in accordance with various embodiments of the present invention. It may be noted that to explain the system 200, references will be made to the system elements of FIG. 1A and FIG. 1B. The system 200 includes the pump 105, the filtering arrangement 110, the plurality of red-mud lumps 115, the red-mud pond 120 and the process water lake 125. The filtering arrangement 110 includes one or more slurry storage chamber arrangements 205, one or more filter chamber arrangements 210a-g, one or more water squeezing chamber arrangements 215, one or more filtrate collecting arrangements 220, a wash tank 225, an air compression arrangement 230, a drip tray 235 and a conveyor arrangement 240. The pump 105 spurts out the slurry mixture to the one or more slurry storage chamber arrangements 205. The pump 105 (as exemplarily described in detailed description of FIG. 1A) may include but not be limited to the GEHO pumps or any other pump capable of gushing/spurting out the slurry in a sudden and forceful stream to the one or more slurry storage chamber arrangements 205.

The slurry mixture includes the slurry and the one or more de-watering agents in the pre-determined quantity (as exemplarily illustrated in detailed description of FIG. 1A). The pre-determined quantity of the one or more de-watering agents is based on a moisture content of the slurry, the surface tension of the aqueous content of the slurry, the quantity of the slurry and the like. The surface tension is a contractive tendency of the surface of a liquid that allows the liquid to resist an external force. In an embodiment of the present invention, 50-500 grams of the one or more de-watering agents is mixed with per ton of the slurry. In an embodiment of the present invention, the slurry includes two or more of sodium hydroxide, sodium carbonate, ferric oxide, titanium dioxide, silica and alumina.

In an embodiment of the present invention, capacity of each of the one or more slurry storage chamber arrangements 205 is 269 cubic metres. The one or more slurry storage chamber arrangements 205 store the slurry mixture. In an embodiment of the present invention, the one or more de-watering agents may be added to the slurry during filtering in the one or more filter chamber arrangements 210a-g. In addition, the one or more slurry storage chamber arrangements 205 feeds the slurry mixture into the one or more filter chamber arrangements 210a-g through one or more discharge common headers (as exemplarily described in detailed description of FIG. 3). In an embodiment of the present invention, the one or more filter chamber arrangements 210a-g is high pressure plate and frame cum membrane filters. The high pressure plate and frame cum membrane filters separates the aqueous content from the slurry by the simultaneous action of the one or more de-watering agents and the physical force.

The feeding of the slurry mixture into the one or more filter chamber arrangements 210a-g is performed by applying a first physical force to the slurry mixture at a first pre-defined pressure. The first pre-defined pressure includes a pressure range of 7-10 bars. Moreover, the one or more water squeezing chamber arrangements 215 squeezes the slurry mixture to separate the aqueous content from the slurry mixture in each of the one or more filter chamber arrangements 210a-g (as examplarily described in detailed description of FIG. 3).

The one or more filter chamber arrangements 210a-g discharges a filtrate generated during the removal of the aqueous content from the slurry into the one or more filtrate collecting arrangements 220 (as elaborated with detailed description of FIG. 3). The wash tank 225 collects the filtrate from the one or more filtrate collecting arrangements 220. The wash tank 225 may include but not be limited to the tank 130 or any other water tank capable of collecting the filtrate or any other liquid. The filtrate collected in the wash tank 225 may be utilized for washing application of the plurality of red-mud particles in a tail end thickener.

Going further, the one or more filter chamber arrangements 210a-g experiences a pressure of compressed air through the air compression arrangement 230 to push remnant slurry mixture present on a feed line of each of the one or more filter chamber arrangements 210a-g back to the one or more slurry storage chamber arrangements 205. The plurality of red-mud lumps 115 is formed in between filter plates of the one or more filter chamber arrangements 210a-g. Further, the drip tray 235 opens and the plurality of red-mud lumps 115 falls out from individual plates of each of the one or more filter chamber arrangements 210a-g by releasing the pressure of filter press containing the one or more filter chamber arrangements 210a-g.

The plurality of red-mud lumps 115 falls out from the individual plates of each of the one or more filter chamber arrangements 210a-g into the red-mud pond 120 through the conveyor arrangement 240 (as exemplarily illustrated in detailed description of FIG. 2B). Further, the red-mud pond 120 passes the aqueous content left in the plurality of red-mud lumps 115 to the process water lake 125. The process water lake 125 transfers the aqueous content to the wash tank 225 and the wash tank 225 passes the aqueous content to the tail end thickener for washing of the plurality of red-mud particles. In an embodiment of the present invention, the wash tank 225 may be the tank 130 or any other water tank capable of collecting the aqueous content or any other liquid. In an embodiment of the present invention, a moisture content of the extracted plurality of red-mud lumps 115 is less than 18 percent.

It may be noted that in FIG. 2A, the wash tank 225 collects the discharged filtrate from the one or more filtrate collecting arrangements 220 and the aqueous content from the process water lake 125, however those skilled in the art would appreciate that there may be more number of wash tanks used for collecting the filtrate and the aqueous content.

FIG. 2B illustrates the system 200 for providing more detailed functioning of the filtering arrangement 110 for extracting the plurality of red-mud lumps 115 from the slurry, in accordance with various embodiments of the present invention. It may be noted that to explain the FIG. 2B, references will be made to the system elements of FIG. 1A, FIG. 1B and FIG. 2A. The FIG. 2B includes the pump 105, the filtering arrangement 110, the red-mud pond 120 and the process water lake 125. The filtering arrangement 110 includes the one or more slurry storage chamber arrangements 205, the one or more filter chamber arrangements 210a-g, the one or more water squeezing chamber arrangements 215, the one or more filtrate collecting arrangements 220, the wash tank 225, the air compression arrangement 230, the drip tray 235 and the conveyor arrangement 240 (as illustrated in detailed description of FIG. 2A). The conveyor arrangement 240 includes a filter discharge conveyor 245, a common inclined conveyer 250 and a tripper conveyer 255.

The pump 105 spurts out the slurry mixture to the one or more slurry storage chamber arrangements 205 (as exemplarily described in detailed description of FIG. 1A and FIG. 2A). The slurry mixture includes the slurry and the one or more de-watering agents in the pre-determined quantity (as exemplarily illustrated in detailed description of FIG. 1A and FIG. 2A). The one or more slurry storage chamber arrangements 205 store the slurry mixture. In addition, the one or more slurry storage chamber arrangements 205 feeds the slurry mixture into the one or more filter chamber arrangements 210a-g through one or more discharge common headers (as exemplarily described in detailed description of FIG. 3). In an embodiment of the present invention, the one or more filter chamber arrangements 210a-g include the high pressure plate and frame cum membrane filters. The high pressure plate and frame cum membrane filters separate the aqueous content from the slurry by the simultaneous action of the one or more de-watering agents and the physical force.

The feeding of the slurry mixture into the one or more filter chamber arrangements 210a-g is performed by applying the first physical force to the slurry mixture at the first pre-defined pressure (as exemplarily illustrated in detailed description of FIG. 2A). The first pre-defined pressure includes a pressure range of 7-10 bars. Moreover, the one or more water squeezing chamber arrangements 215 squeezes the slurry mixture to separate the aqueous content from the slurry mixture in each of the one or more filter chamber arrangements 210a-g (as exemplarily described in detailed description of FIG. 3).

The one or more filter chamber arrangements 210a-g discharges the filtrate generated during the removal of the aqueous content from the slurry into the one or more filtrate collecting arrangement 220 (as elaborated with detailed description of FIG. 3). The wash tank 225 collects the filtrate from the one or more filtrate collecting arrangement 220 (as illustrated in detailed description of FIG. 2A).

As explained earlier, the one or more filter chamber arrangements 210a-g experiences the pressure of compressed air through the air compression arrangement 230 to push the remnant slurry mixture present on the feed line of each of the one or more filter chamber arrangements 210a-g back to the one or more slurry storage chamber arrangements 205. The plurality of red-mud lumps 115 is formed in between the filter plates of the one or more filter chamber arrangements 210a-g. Further, the drip tray 235 opens and the plurality of red-mud lumps 115 falls out from the individual plates of each of the one or more filter chamber arrangements 210a-g by releasing the pressure of the filter press containing the one or more filter chamber arrangements 210a-g.

Further, the plurality of red-mud lumps 115 falls out from the individual plates of each of the one or more filter chamber arrangements 210a-g on the filter discharge conveyor 245. The filter discharge conveyor 245 forwards the plurality of red-mud lumps 115 to the common inclined conveyer 250. Further, the common inclined conveyer 250 forwards the plurality of red-mud lumps 115 to the tripper conveyer 255. The tripper conveyer 255 advances the plurality of red-mud lumps 115 into the red-mud pond 120. In an embodiment of the present invention, capacities of the filter discharge conveyor 245 is in a range of 270 tons per hour, each of the common inclined conveyer 250 and the tripper conveyer 255 is in a range of 810 tons per hour.

As explained earlier, the red-mud pond 120 passes the aqueous content left in the plurality of red-mud lumps 115 to the process water lake 125. The process water lake 125 transfers the aqueous content to the wash tank 225 and the wash tank 225 passes the aqueous content to the tail end thickener for washing of the plurality of red-mud particles.

It may be noted that in FIG. 2B, the plurality of red-mud lumps 115 passes to the red-mud pond 120 through the filter discharge conveyor 245, the common inclined conveyer 250 and the tripper conveyer 255, however those skilled in the art would appreciate that there can be more number of conveyors used for discharging the plurality of red-mud lumps 115 to the red-mud pond 120.

FIG. 3 illustrates a system 300 for providing a detailed functioning of a filter chamber arrangement of the one or more filter chamber arrangements 210a-g of the filtering arrangement 110, in accordance with various embodiments of the present invention. It may be noted that to explain the system 300, references will be made to the system elements of FIG. 1A, FIG. 1B, FIG. 2A and FIG. 2B. The system 300 includes the high pressure plate and frame cum membrane filter 305, one or more filter feed pumps 310, a feed inlet valve 315, a control valve 320, a pneumatic ON/OFF valve 325 of recirculation line, a core blow valve 330 of the air compression arrangement 230, the one or more water squeezing chamber arrangements 215 and the one or more filtrate collecting arrangements 220. The one or more water squeezing chamber arrangements 215 includes one or more water squeezing reservoirs 335, one or more squeeze wash pumps 340, a squeezing water inlet valve 345 and a discharge valve 350. Further, the one or more filtrate collecting arrangements 220 includes a filtrate discharge valve 355, one or more launders 360, one or more filtrate reservoirs 365 and one or more filtrate pumps 370.

The filter plates of the high pressure plate and frame cum membrane filter 305 remain closed for duration of 2 minutes before the feeding of the slurry mixture from the one or more slurry storage chamber arrangements 205 into the high pressure plate and frame cum membrane filter 305 is performed. However, during the feeding of the slurry mixture, the pneumatic ON/OFF valve 325 of the recirculation line, the core blow valve 330, the squeezing water inlet valve 345 and the filtrate discharge valve 355 remains closed. The feeding of the slurry mixture into the high pressure plate and frame cum membrane filter 305 take place through the feed inlet valve 315.

Going further, the one or more filter feed pumps 310 connecting the one or more slurry storage chamber arrangements 205 and the high pressure plate and frame cum membrane filter 305 through the one or more discharge common headers feeds/spurts the slurry mixture from the one or more slurry storage chamber arrangements 205 into the high pressure plate and frame cum membrane filter 305 of the one or more filter chamber arrangements 210a-g. The feeding of the slurry mixture is performed by applying the first physical force to the slurry mixture at the first pre-defined pressure for duration of 8 minutes (as exemplarily described in detailed description of FIG. 2A). The feed inlet valve 315 automatically closes after the feeding of the slurry mixture.

In an embodiment of the present invention, the one or more filter feed pumps 310 are variable frequency drive (VFD) type pumps having a motor of 200 KW and a capacity of 320 cubic metres per hour. Each of the one or more filter feed pumps 310 are connected individually to each of the one or more filter chamber arrangements 210a-g. Moreover, each of the one or more filter feed pumps 310 has the control valve 320 at its discharge. The control valve 320 automatically regulates downstream pressure and provides a constant pressure during flow of the slurry mixture into the high pressure plate and frame cum membrane filter 305. Further, each of the one or more filter feed pumps 310 are connected with the pneumatic ON/OFF valve 325 of the blow recirculation line. The re-circulation line having the pneumatic ON/OFF valve 325 allows continual back flow of the remnant slurry/other liquids.

Going further, the one or more water squeezing chamber arrangements 215 squeezes the slurry mixture present in the filter plates of the high pressure plate and frame cum membrane filter 305 to separate the aqueous content from the slurry mixture. The one or more squeeze wash pumps 340 directs a stream of a washing fluid from the one or more water squeezing reservoirs 335 to the slurry mixture in the high pressure plate and frame cum membrane filter 305 through the squeezing water inlet valve 345. The directing of the washing fluid into the high pressure plate and frame cum membrane filter 305 is performed for duration of 3 minutes by applying a second physical force to the slurry mixture at a second pre-defined pressure. The difference between the second pre-defined pressure and the first pre-defined pressure is in a range of 3-6 bars. The second pre-defined pressure includes a pressure of 12-13 bars. The squeezing helps in proper filtration of the slurry mixture. In an embodiment of the present invention, capacity of each of the one or more water squeezing reservoirs 335 is 169 cubic metres. Further, the applying of the second physical force releases the aqueous content of the plurality of red-mud lumps 115.

In an embodiment of the present invention, the one or more squeeze wash pumps 340 are positive displacement pumps having a motor of 75 KW and a capacity of 150 cubic metres per hour. Going further, the squeezing water inlet valve 345 closes and the discharge valve 350 opens and the washing fluid re-circulates to the one or more water squeezing reservoirs 335.

Moreover, the high pressure plate and frame cum membrane filter 305 discharges the filtrate generated during the above stated process through the one or more filtrate collecting arrangements 220. The discharged filtrate moves into the one or more launders 360. The one or more filtrate reservoirs 365 collects the filtrate from the one or more launders 360 through a common header by gravity flow. Further, the one or more filtrate pumps 370 connected to the one or more filtrate reservoirs 365 pumps out the filtrate from the one or more filtrate reservoirs 365 to the wash tank 212 (as exemplarily described in detailed description of FIG. 2A). In an embodiment of the present invention, the one or more filtrate pumps 370 are centrifugal type pumps having a motor of 90 KW and a capacity of 330 cubic metres per hour. The one or more filtrate reservoirs 365 may include but not be limited to the one or more reservoirs or any other one or more tanks capable of collecting the filtrate.

Going further, the high pressure plate and frame cum membrane filter 305 experiences the pressure of compressed air through the core blow valve 330 of the air compression arrangement 230 for a duration of 1 minute to push the remnant slurry mixture present on the feed line of the high pressure plate and frame cum membrane filter 305 back to the one or more slurry storage chamber arrangements 205. In an embodiment of the present invention, each of the filter plates has a hole that acts as a feeding point for each of the filter plates. Joining of each of the filter plates forms a pipe referred to as the feed line.

Further, the drip tray 235 opens and the plurality of red-mud lumps 115 falls out from the individual plates of each of the high pressure plate and frame cum membrane filter 305 into the red-mud pond 120 through the conveyors arrangement 240 (as elaborated in detailed description of FIG. 2B).

The plurality of red-mud lumps 115 is stored as vertical stacks in the red-mud pond 120. Further, the red-mud pond 120 passes the aqueous content left in the plurality of red-mud lumps 115 to the process water lake 125. The process water lake 125 transfers the aqueous content to the wash tank 212 and the wash tank 212 passes the aqueous content to the tail end thickener for the washing of the plurality of red-mud particles. In an embodiment of the present invention, each of the plurality of red-mud lumps 115 includes at least one of sodium as the sodium hydroxide and sodium carbonate, iron as the ferric oxide, titanium as the titanium dioxide, silicon as the silica and aluminum as the alumina.

In an embodiment of the present invention, a process of opening of the high pressure plate and frame cum membrane filter 305 and discharging of the plurality of red-mud lumps 115 is performed for duration of 6 minutes. Further, closing of the drip tray 235 and readiness of the high pressure plate and frame cum membrane filter 305 is performed for duration of 2 minutes. In an embodiment of the present invention, the process of extracting the plurality of red-mud lumps 115 from the slurry mixture is performed for duration of 22 minutes.

In an embodiment of the present invention, the high pressure plate and frame cum membrane filter 305 includes one or more membrane plates and one or more recessed plates placed alternatively to each other. The squeezing is performed in the one or more membrane plates to reduce the moisture content of the plurality of red-mud lumps 115. However, no squeezing is performed in the one or more recessed plates.

It may be noted that in FIG. 3, the high pressure plate and frame cum membrane filter 305 removes the aqueous content from the slurry mixture; however those skilled in the art would appreciate that there may be more number of high pressure plate and frame cum membrane filters capable of removing the aqueous content from the slurry mixture.

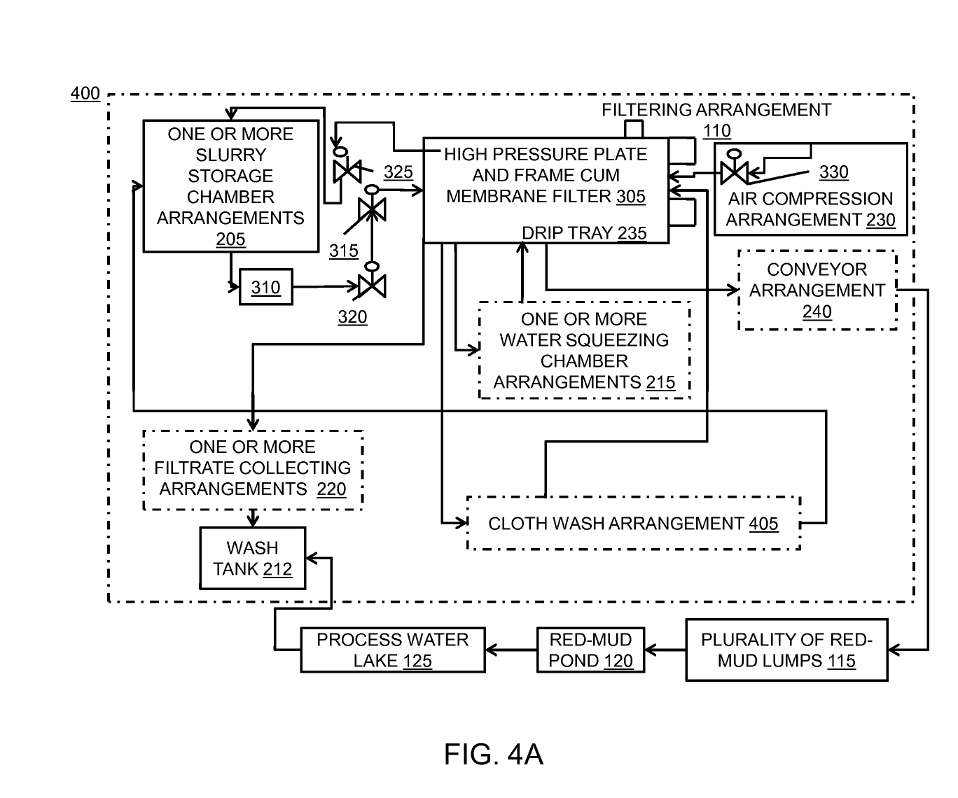

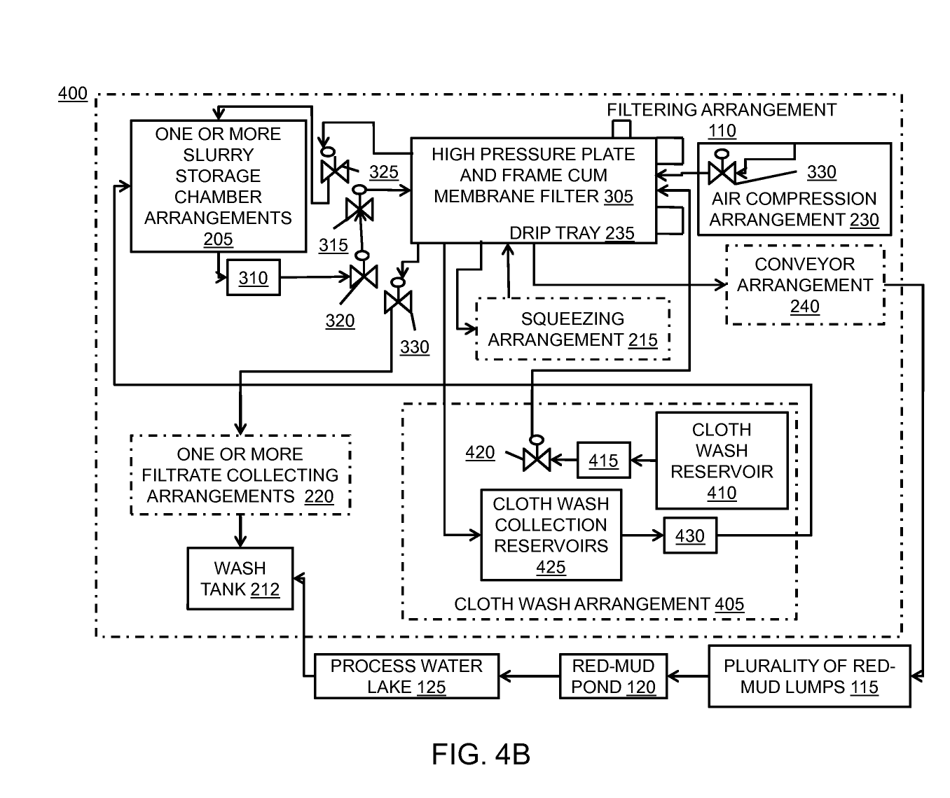

FIG. 4A illustrates a system 400 for demonstrating a cloth washing process of the high pressure plate and frame cum membrane filter 305, in accordance with various embodiments of the present invention. It may be noted that to explain the system 400, references will be made to the system elements of FIG. 1A, FIG. 1B, FIG. 2A, FIG. 2B and FIG. 3. The FIG. 4A includes a cloth wash arrangement 405. The filtering arrangement 110 implements a provision for the cloth washing of the high pressure plate and frame cum membrane filter 305 for a pre-defined time interval. In an embodiment of the present invention, the pre-defined time interval for the cloth washing is one time per day for 60 minutes. The cloth washing process of the high pressure plate and frame cum membrane filter 305 is described in detailed description of FIG. 4B.

FIG. 4B illustrates the system 400 for describing in detail the cloth washing process of the high pressure plate and frame cum membrane filter 305, in accordance with various embodiments of the present invention. It may be noted that to explain the FIG. 4B, references will be made to the system elements of FIG. 1A, FIG. 1B, FIG. 2A, FIG. 2B, FIG. 3 and FIG. 4A. The FIG. 4B includes the cloth wash arrangement 405. Further, the cloth wash arrangement 405 includes a cloth wash reservoir 410, one or more cloth wash pumps 415, a cloth wash inlet valve 420, a cloth wash collection reservoir 425 and one or more cloth wash collection pumps 430.

The high pressure plate and frame cum membrane filter 305 discharges the plurality of red-mud lumps 115 and the filtrate generated during the process of squeezing (as exemplarily illustrated in detailed description of FIG. 3). The one or more cloth wash pumps 415 directs a stream of water from the cloth wash reservoir 410 to the filter plates of the high pressure plate and frame cum membrane filter 305 using the cloth wash inlet valve 420 to wash the cloth of the high pressure plate and frame cum membrane filter 305. In an embodiment of the present invention, the one or more cloth wash pumps 415 are positive displacement type pumps having a motor of 55 KW and a capacity of 15 cubic metres per hour.

In an embodiment of the present invention, the drip tray 235 and other valves (as exemplarily illustrated in detailed description of FIG. 3) remains closed during the directing of the stream of water to the filter plates of the high pressure plate and frame cum membrane filter 305. In another embodiment of the present invention, capacity of the cloth wash reservoir 410 is 169 cubic metres. Further, the one or more launders 360 collects the cloth washing liquor from the high pressure plate and frame cum membrane filter 305 through an opening in the drip tray 235. Furthermore, the high pressure plate and frame cum membrane filter 305 sends the cloth washing liquor to the cloth wash collection reservoir 425 by gravity. In an embodiment of the present invention, capacity of the cloth wash collection reservoir 425 is 6.28 cubic metres. The one or more cloth wash collection pumps 430 having a capacity of 10 cubic metres per hour forces the cloth washing liquor collected in the cloth wash collection reservoir 425 to the one or more slurry storage chamber arrangements 205.

It may be noted that in FIG. 4, the one or more cloth wash pumps 415 directs the stream of water from the cloth wash reservoir 410; however those skilled in the art would appreciate that the one or more cloth wash pumps 415 may direct the stream of water from one or more cloth wash reservoirs. It may also be noted that in FIG. 4, the cloth washing liquor is collected in the cloth wash collection reservoir 425; however those skilled in the art would appreciate that the cloth washing liquor may be collected in one or more cloth wash collection reservoirs. It may also be noted that in FIG. 4, the one or more cloth wash pumps 415 directs the stream of water from the cloth wash reservoir 410 to the filter plates of the high pressure plate and frame cum membrane filter 305; however those skilled in the art would appreciate that the one or more cloth wash pumps 415 may direct the stream of water from the cloth wash reservoir 410 to the filter plates of the one or more filter chamber arrangements 210a-g.

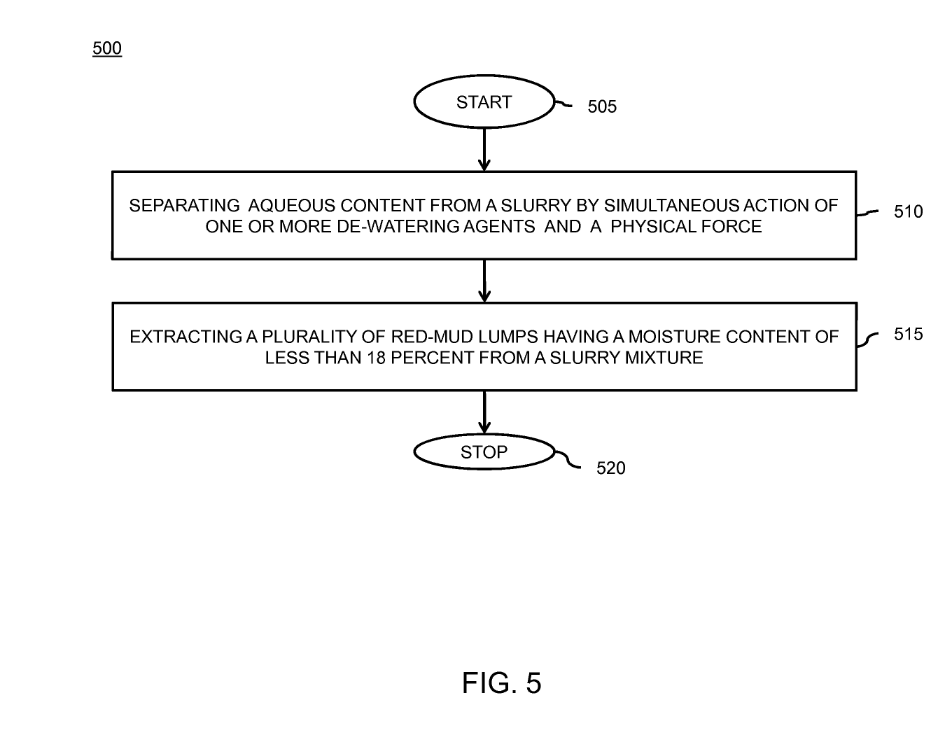

FIG. 5 illustrates a flowchart 500 for extracting the plurality of red-mud lumps 115 from the slurry, in accordance with various embodiments of the present invention. It may be noted that to explain the flowchart 500, references will be made to the system elements of FIG. 1A, FIG. 1B, FIG. 2A, FIG. 2B, FIG. 3, FIG. 4A and FIG. 4B. The flowchart 500 initiates at step 505. Following step 505, at step 510, the filtering arrangement 110 separates the aqueous content from the slurry by the simultaneous action of the one or more de-watering agents and the physical force. At step 515, the filtering arrangement 110 extracts the plurality of red-mud lumps 115 having the moisture content of less than 18 percent from the slurry mixture. The flowchart 500 terminates at step 520.

It may be noted that the flowchart 500 is explained to have above stated process steps; however, those skilled in the art would appreciate that the flowchart 500 may have more/less number of process steps which may enable all the above stated embodiments of the present invention.

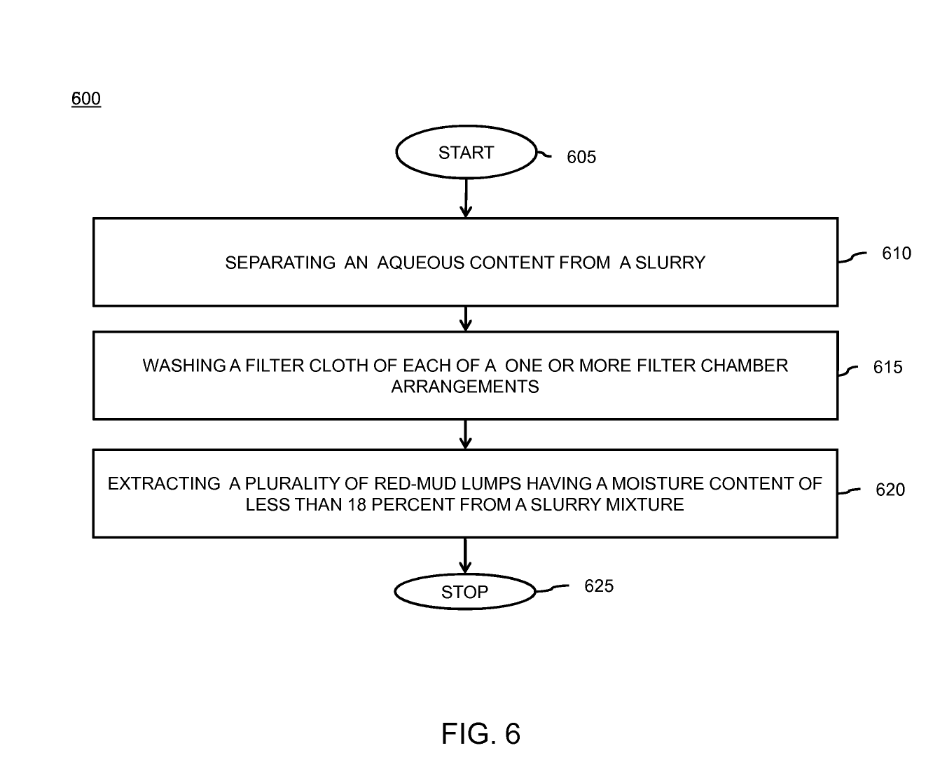

FIG. 6 illustrates another flowchart 600 for extracting the plurality of red-mud lumps 115 from the slurry, in accordance with various embodiments of the present invention. It may be noted that to explain the flowchart 600, references will be made to the system elements FIG. 1A, FIG. 1B, FIG. 2A, FIG. 2B, FIG. 3, FIG. 4A, FIG. 4B and the process steps of FIG. 5. The flowchart 600 initiates at step 605. At step 610, the filtering arrangement 110 separates the aqueous content from the slurry. At step 615, the filtering arrangement 110 washes the filter cloth of each of the one or more filter chamber arrangements 210a-g. At step 620, the filtering arrangement 110 extracts the plurality of red-mud lumps 115 having the moisture content of less than 18 percent from the slurry mixture. The flowchart 600 terminates at step 625.

It may be noted that the flowchart 600 is explained to have above stated process steps; however, those skilled in the art would appreciate that the flowchart 600 may have more/less number of process steps which may enable all the above stated embodiments of the present invention.

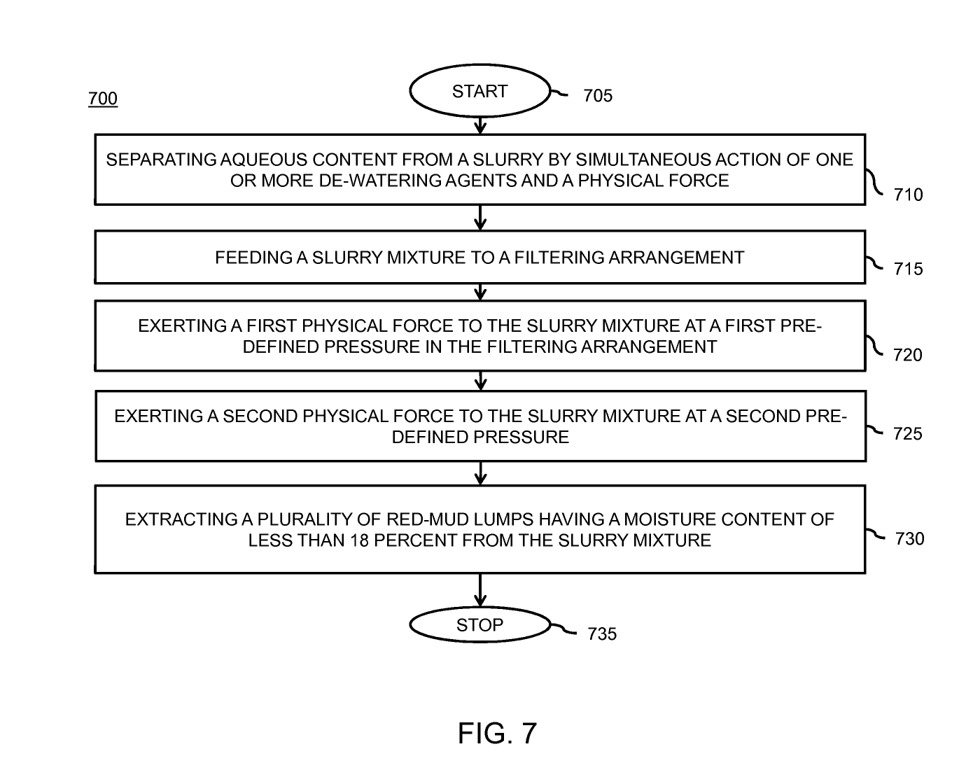

FIG. 7 illustrates yet another flowchart 700 for extracting the plurality of red-mud lumps 115 from the slurry, in accordance with various embodiments of the present invention. It may be noted that to explain the flowchart 700, references will be made to the system elements FIG. 1A, FIG. 1B, FIG. 2A, FIG. 2B, FIG. 3, FIG. 4A, FIG. 4B and the process steps of FIG. 5 and FIG. 6. The flowchart 700 initiates at step 705. At step 710, the filtering arrangement 110 separates the aqueous content from the slurry by simultaneous action of the one or more de-watering agents and the physical force. The separating is explained by the process steps 715, 720 and 725. At step 715, the pump 105 feeds the slurry mixture to the filtering arrangement 110. At step 720, the one or more filter feed pumps 310 exert the first physical force to the slurry mixture at the first pre-defined pressure in the filtering arrangement 110. At step 725, the one or more squeeze wash pumps 340 exert the second physical force to the slurry mixture at the second pre-defined pressure. Following the process steps of 715, 720 and 725, at step 730, the filtering arrangement 110 extracts the plurality of red-mud lumps 115 having the moisture content of less than 18 percent from the slurry mixture. The flowchart 700 terminates at step 735.

It may be noted that the flowchart 700 is explained to have above stated process steps; however, those skilled in the art would appreciate that the flowchart 700 may have more/less number of process steps which may enable all the above stated embodiments of the present invention.

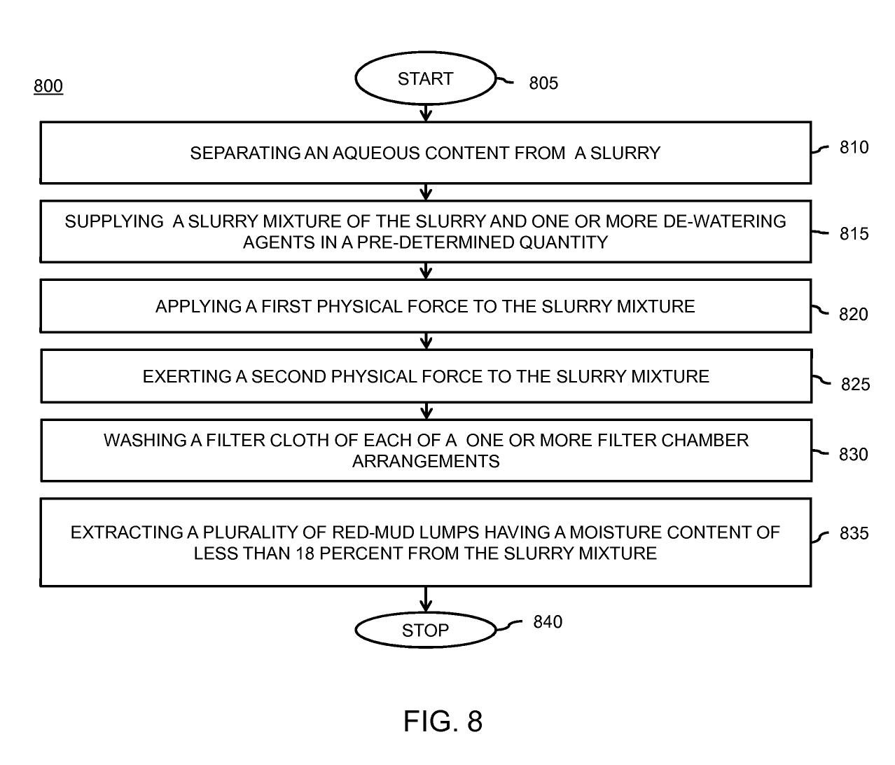

FIG. 8 illustrates yet another flowchart 800 for extracting the plurality of red-mud lumps 115 from the slurry, in accordance with various embodiments of the present invention. It may be noted that to explain the flowchart 800, references will be made to the system elements FIG. 1A, FIG. 1B, FIG. 2A, FIG. 2B, FIG. 3, FIG. 4A, FIG. 4B and the process steps of FIG. 5, FIG. 6 and FIG. 7. The flowchart 800 initiates at step 805. At step 810, the filtering arrangement 110 separates the aqueous content from the slurry. The separating is explained by the process steps 815, 820 and 825. At step 815, the pump 105 supplies the slurry mixture of the slurry and one or more de-watering agents in the pre-determined quantity. At step 820, the one or more filter feed pumps 310 apply the first physical force to the slurry mixture. At step 825, the one or more squeeze wash pumps 340 exert the second physical force to the slurry mixture. Following the process steps of 815, 820 and 825, at step 830, the filtering arrangement 110 washes the filter cloth of each of the one or more filter chamber arrangements. At step 835, the filtering arrangement 110 extracts the plurality of red-mud lumps 115 having the moisture content of less than 18 percent from the slurry mixture. The flowchart 800 terminates at step 840.

In an example, a GEHO pump spurts the red-mud slurry containing red-mud mixed with a liquid into the slurry storing reservoirs. The slurry storing reservoirs feeds the red-mud slurry into filter chamber arrangements at a pressure of 7 bars that remove the liquid from the red-mud slurry by using de-watering agents like dialkyl sulfosuccinates and polyalkoxylated amines. This feeding process takes place for 8 minutes. Further, the filter chamber arrangements pressurize the red-mud slurry by directing water from a water squeezing reservoir on the red-mud slurry to increase the pressure up to 12-13 bars. The water is then re-circulated back to the slurry storing reservoirs. This squeezing process takes place for 3 minutes. In addition, the filtrate discharged from the filter chamber arrangements is collected in one or more filtrate reservoirs through one or more launders. The filtrate is then collected in the wash tank. Moreover, the air present in the one or more filter chamber arrangements is compressed to push back the remnant slurry into the one or more slurry storing reservoirs. This step takes place for 1 minute. Finally, the one or more filter chamber arrangements extracts out the red-mud cakes having reduced moisture content of less than 18 percent into the red-mud pond through conveyors. The step of filter opening and the cake discharge takes place for another 6 minutes. Then drip tray of one or more filter chamber arrangements takes 2 minutes to close. The liquid present in the red-mud cakes is then transferred to the wash tank. In addition, the cloth of each of the filter chamber arrangements is washed once a day for 60 minutes by directing the water from the cloth wash reservoir on the cloth. This water is then re-circulated from the one or more filter chamber arrangements to the cloth wash collection reservoir.

It may be noted that the flowchart 800 is explained to have above stated process steps; however, those skilled in the art would appreciate that the flowchart 800 may have more/less number of process steps which may enable all the above stated embodiments of the present invention.

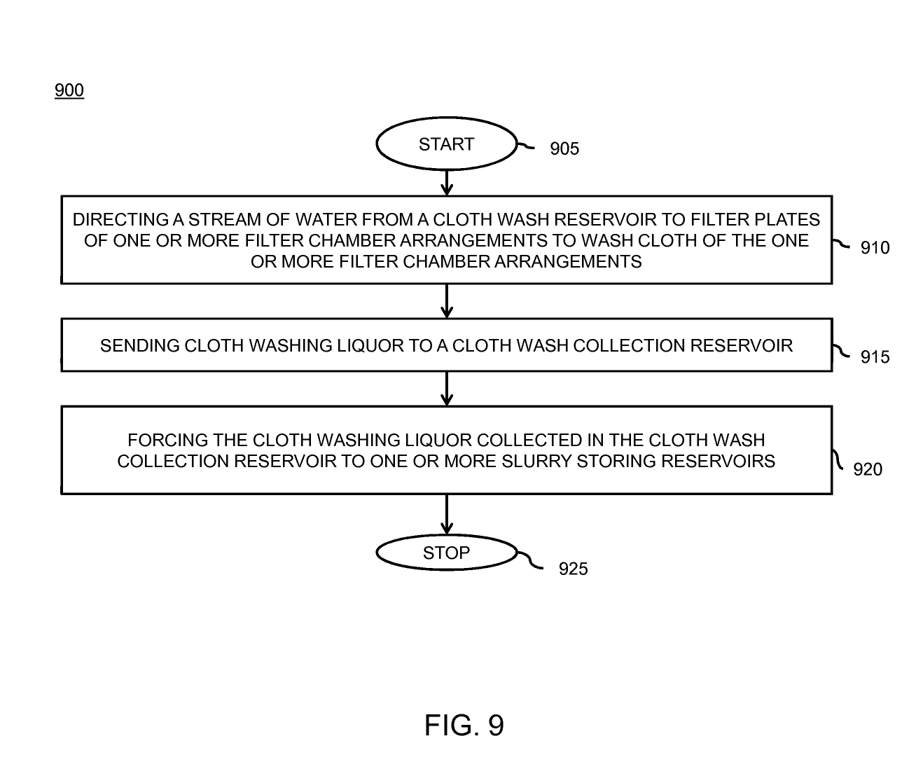

FIG. 9 illustrates a flowchart 900 for demonstrating the cloth washing process of the one or more filter chamber arrangements 210a-g, in accordance with various embodiments of the present invention. It may be noted that to explain the flowchart 900, references will be made to the system elements of FIG. 1A, FIG. 1B, FIG. 2A, FIG. 2B, FIG. 3, FIG. 4A, FIG. 4B and the process steps of FIG. 5, FIG. 6, FIG. 7 and FIG. 8. The flowchart 900 initiates at step 905. Following step 905, at step 910, the one or more cloth wash pumps 415 direct the stream of water from the cloth wash reservoir 410 to the filter plates of the one or more filter chamber arrangements 210a-g to wash the cloth of the one or more filter chamber arrangements 210a-g. At step 915, the one or more filter chamber arrangements 210a-g sends the cloth washing liquor to the cloth wash collection reservoir 425. At step 920, the one or more cloth wash collection pumps 430 forces the cloth washing liquor collected in the cloth wash collection reservoir 425 to the one or more slurry storage chamber arrangements 205. The flowchart 900 terminates at step 925.

It may be noted that the flowchart 900 is explained to have above stated process steps; however, those skilled in the art would appreciate that the flowchart 900 may have more/less number of process steps which may enable all the above stated embodiments of the present invention.

The above stated methods and system have many advantages. The above stated method and system provides possibility of utilizing the plurality of red-mud lumps 115 as a raw material in cement industry in place of laterite/iron ore fines for optimally utilizing natural resources and minimizing green house gas emissions by reducing 15 percent of caustic consumption. Further, the above stated method and system provides possibility of recovering elements including the titanium, vanadium, pig iron, the alumina and the like. Furthermore, the method and system minimizes land requirement by 50% to 60% and eliminates environmental hazards caused due to storage of wet red-mud. In addition, the method and system enables alumina refineries to turn as zero waste refineries due to production of the plurality of red-mud lumps 115. In addition, the caustic present in the slurry neutralizes the acidic sulphur trioxide produced during cement manufacturing process by forming sodium sulphate.

While the invention has been presented with respect to certain specific embodiments, it will be appreciated that many modifications and changes may be made by those skilled in the art without departing from the spirit and scope of the invention. It is intended, therefore, by the appended claims to cover all such modifications and changes as fall within the true spirit and scope of the invention.

What is claimed is:

1. A filtering arrangement for extracting a plurality of red-mud lumps from a slurry, said filtering arrangement comprising:
one or more slurry storage chamber arrangements adapted to receive a slurry mixture, wherein said slurry mixture comprises said slurry and one or more de-watering agents in a pre-determined quantity, wherein said slurry resulting from alkaline digestion of bauxite and having a plurality of red-mud particles dispersed in an aqueous content;
one or more filter chamber arrangements adapted to filter said aqueous content from said slurry mixture, wherein said slurry mixture is received from said one or more slurry storage chamber arrangements by a first physical force at a first pre-defined pressure to extract said plurality of red-mud lumps, wherein said plurality of red-mud lumps having a moisture content of less than 18 percent; and
one or more water squeezing chamber arrangements adapted to apply a second physical force at a second pre-defined pressure to said slurry mixture, wherein said one or more water squeezing chamber arrangements exerts said second physical force by directing a stream of water on said slurry mixture in said filtering arrangement, wherein a difference between said second pre-defined pressure and said first pre-defined pressure is in a range of 3-6 bars.

2. The filtering arrangement as recited in claim 1, further comprising one or more filtrate collecting arrangements adapted to collect a filtrate generated from said extraction of said plurality of red-mud lumps from said slurry mixture.

3. The filtering arrangement as recited in claim 1, further comprising a cloth washing arrangement adapted to wash a filter cloth of each of said one or more filter chamber arrangements of said filtering arrangement by advancing a stream of water to said filter cloth for a pre-defined time interval.

4. The filtering arrangement as recited in claim 1, wherein each of said one or more filter chamber arrangements being high pressure plate and frame cum membrane filters.

5. The filtering arrangement as recited in claim 1, wherein each of said extracted plurality of red-mud lumps comprises at least one of sodium as sodium hydroxide and sodium carbonate, iron as ferrous oxide, titanium as titanium dioxide, silicon as silica and aluminium as alumina.

6. The filtering arrangement as recited in claim 1, further comprising an air compression arrangement to pass compressed air in each of said one or more filter chamber arrangements to push remnant slurry to said one or more slurry storage chamber arrangements.

7. A method for extracting a plurality of red-mud lumps from a slurry, said slurry resulting from alkaline digestion of bauxite and having a plurality of red-mud particles dispersed in an aqueous content, said method comprising:
separating said aqueous content from said slurry by simultaneous action of one or more de-watering agents and a physical force, wherein said one or more de-watering agents affects at least one of surface tension and drainage of said aqueous content of said slurry and water repellent property of said plurality of red-mud particles, and wherein said separating of said aqueous content from said slurry comprises:
feeding a slurry mixture to a filtering arrangement, wherein said slurry mixture comprises said slurry and said one or more de-watering agents in a pre-determined quantity, wherein said filtering arrangement being utilized for said extracting of said plurality of red-mud lumps from said slurry;
exerting a first physical force to said slurry mixture at a first pre-defined pressure in said filtering arrangement; and
exerting a second physical force to said slurry mixture at a second pre-defined pressure, wherein a difference between said second pre-defined pressure and said first pre-defined pressure is in a range of 3-6 bars;
extracting said plurality of red-mud lumps having a moisture content of less than 18 percent from said slurry mixture.

8. The method as recited in claim 7, wherein said slurry comprises two or more of sodium hydroxide, sodium carbonate, ferrous oxide, titanium dioxide, silica and alumina, and wherein each of said plurality of red-mud lumps comprises at least one of sodium as said sodium hydroxide and said sodium carbonate, iron as said ferrous oxide, titanium as said titanium dioxide, silicon as said silica and aluminium as said alumina.

9. The method as recited in claim 7, wherein said pre-determined quantity of said one or more de-watering agents is based on a moisture content of said slurry and said surface tension of said aqueous content of said slurry.

10. The method as recited in claim 7, wherein 50-500 grams of said one or more de-watering agents is mixed with per ton of said plurality of red-mud particles.

11. The method as recited in claim 7, wherein said simultaneous action of said one or more de-watering agents and said physical force on said slurry mixture is performed by at least one of high pressure plate and frame cum membrane filters of said filtering arrangement.

12. The method as recited in claim 7, wherein said exerting of said second physical force to said slurry mixture comprises directing a stream of a washing fluid to said slurry mixture in said filtering arrangement, and wherein said directing squeezes said slurry mixture to filter said aqueous content from said slurry mixture in said filtering arrangement.

13. The method as recited in claim 1, wherein said extracting of said plurality of red-mud lumps having said moisture content of less than 18 percent comprises said separating of said slurry mixture to said filtering arrangement for 8 minutes, said exerting of said first physical force and said exerting of said second physical force for 3 minutes; and a compression of air for 1 minute, opening of said filtering arrangement for discharging of said plurality of red-mud lumps for 6 minutes and closing of a drip tray and readiness of said filtering arrangement for 2 minutes.

14. The method as recited in claim 1, further comprising collecting a filtrate generated from said extraction of said plurality of red-mud lumps from said slurry mixture.

15. The method as recited in claim 1, further comprising washing a filter cloth of each of said high pressure plate and frame cum membrane filters of said filtering arrangement by advancing a stream of water to said filter cloth for a pre-defined time interval.

16. A method for extracting a plurality of red-mud lumps from a slurry, said slurry resulting from alkaline digestion of bauxite and having a plurality of red-mud particles dispersed in an aqueous content, said method comprising:
separating said aqueous content from said slurry, wherein said separating being triggered by simultaneous action of one or more de-watering agents and a physical force, wherein said one or more de-watering agents affects at least one of surface tension and drainage of said aqueous content of said slurry and water repellent property of said plurality of red-mud particles, wherein said separating of said aqueous content from said slurry comprises:
supplying a slurry mixture of said slurry and said one or more de-watering agents in a pre-determined quantity, wherein said pre-determined quantity of said one or more de-watering agents is based on a moisture content of said slurry and said surface tension of said aqueous content of said slurry, wherein said filtering arrangement being utilized for said extracting of said plurality of red-mud lumps from said slurry, wherein said slurry being fed to said filtering arrangement;
applying a first physical force to said slurry mixture, wherein said first physical force is applied at a first pre-defined pressure in said filtering arrangement; and
exerting a second physical force to said slurry mixture, wherein said second physical force being exerted at a second pre-defined pressure, wherein a difference between said second pre-defined pressure and said first pre-defined pressure is in a range of 3-6 bars;
washing a filter cloth of each of a one or more filter chamber arrangements of said filtering arrangement; and
extracting said plurality of red-mud lumps having a moisture content of less than 18 percent from said slurry mixture

17. The method as recited in claim 16, wherein said washing being performed by advancing a stream of water to said filter cloth for a pre-defined time interval.

18. The method as recited in claim 16, wherein said exerting of said second physical force to said slurry mixture comprises directing a stream of a washing fluid to said slurry mixture in said filtering arrangement, and wherein said directing squeezes said slurry mixture to filter said aqueous content from said slurry mixture in said filtering arrangement.

19. The method as recited in claim 16, further comprising collecting a filtrate generated from said extraction of said plurality of red-mud lumps from said slurry mixture.

20. The method as recited in claim 16, wherein said slurry comprises two or more of sodium hydroxide, sodium carbonate, ferrous oxide, titanium dioxide, silica and alumina, and wherein each of said plurality of red-mud lumps comprises at least one of sodium as said sodium hydroxide and said sodium carbonate, iron as said ferrous oxide, titanium as said titanium dioxide, silicon as said silica and aluminium as said alumina.
